(19) United States
(12) Patent Application Publication
(10) Pub. No.: US 2002/0114221 A1
(43) Pub. Date: Aug. 22, 2002

(54) Dynamic time actuating system and method

(75) Inventor: Niclas Stahl, Montreal (CA)

Correspondence Address: ANDRE M. SZUWALSKI, Jenkens & Gilchrist, P.C., 1445 Ross Avenue, Dallas, TX, 75202-2799, US

(73) Assignee: Telefonaktiebolaget L M Ericsson

(21) Appl. No.: 09/785,336

(22) Filed: Feb. 20, 2001

(51) Int. Cl. G04B 47/06; G04C 21/00; G04C 23/00

(52) U.S. Cl. 368/73; 368/11

(57) ABSTRACT

The invention relates to an actuating system (10) in which the actuating time can be adjusted according to external factors, some of which can be found on one or more servers (19) on the Internet (18).

A user can set a normal actuating time along with certain conditions that might adjust or cancel the time. These conditions may for instance be the weather, traffic situations and ice conditions. A processor (15) gathers the information (26) needed, for example from the servers (19) and calculates if the actuating time should be changed or cancelled.

### BACKGROUND OF THE INVENTION

1. Technical Field of the Invention

The present invention relates to actuating systems and more particularly to an actuating system for actuating predefined actions at certain times where the times may change according to external factors, as well as a method to change the times according to external factors.

2. Description of Related Art

In our seemingly ever more hectic world, time has become a very important factor for people. There is probably more stress owing to lack of time than ever before in history. People rush from meeting to meeting and from appointment to appointment, and as a result people often do not get enough sleep. One of the reasons for this is that people sometimes tend to sleep badly or set the wake-up time unnecessarily early worrying about tomorrow's early appointments, as they fear they will not be able to make it on time. Another reason is that people sometimes get up early intending to do something that they cannot do because of external factors, such as for instance take a plane that is delayed, paint when it is raining or play golf when the course is closed.

Prior Art for alarm clocks teaches various solutions for adjusting the wake-up time according to the weather, primarily sounding the alarm early in case of bad weather, as it is assumed that it will take longer to reach the destination wanted under those conditions.

Some problems with the solutions in the Prior Art are:

the wake-up time is usually set earlier in case of bad weather conditions, not later as may be desired;

the factors controlling the adjustment are usually rigidly set and therefore difficult or impossible to change;

the wake-up time is only dependent on the weather, not on for example the traffic situation; and

only one area is taken into account when setting the time, which is not always the same area as the area a person is interested in.

As can be seen from this, it is apparent that it would be good to have an actuating system for actuating predefined functions where the time to actuate the functions can be changed automatically according to various external factors. Such a system can then for example be used as an alarm clock where the predefined function is the sounding of the alarm. The system can for example also be used for virtually any end where at least one function is to be performed at a specific time, where the time can be changed according to external factors. These ends include, but are not limited to, setting off explosive devices, controlling traffic lights, managing investment portfolios, switching on and off lights at certain variable times, postponing the automated heating of an apartment if the inhabitants' flight is delayed, and rescheduling the sprinkler system at a golf course according to the tee-off times that have been booked.

External factors that could be desired to change the time are for example the weather (locally or further away), the traffic situation, whether a golf course is open, whether the ice is in good condition for skating, if a plane is delayed (or indeed early), or the performance of a stock on a stock exchange.

The present invention seeks to overcome the problems mentioned hereinbefore in providing a dynamic time actuating system and a dynamic time actuating method for actuating predefined functions where the time for actuating the functions can be adjusted according to various pre-set factors, some of which can be external to the system.

### SUMMARY OF THE INVENTION

The present invention is directed to a dynamic time actuating system with an input/output area where the user selects an actuating time, a function to be performed at the actuating time (not necessary if the function is pre-defined), at least one external factor, and at least one condition about the at least one external factor that may change the actuating time. The system then uses an communication unit for obtaining information about the external factor and processes the information, the at least one condition, and the actuating time to either change the actuating time, delete the actuating time or leave the actuating time unchanged. The system further comprises an effectuating unit for effectuating the selected function at the actuating time.

In a further aspect, the invention is directed to a method for operating a dynamic time actuating system. The user selects an actuating time, a function to be performed at the actuating time, at least one external factor, and at least one condition about the at least one external factor regarding the actuating time. Information is then obtained about the external factor, and the information is compared with the at least one condition. Based on the actuating time and the result of the comparison, the actuating time is either changed, deleted, or left unchanged. The selected function is then effectuated at the actuating time.

In yet a further aspect the invention is directed to a method in an actuating system for changing the actuating time according to external factors. The user has stored at least one actuating time and a plurality of conditions relating to the external factors in the system. The method is then used to access information about the external factors relating to the conditions, and evaluate the information with regard to the conditions. Then a decision based on the evaluation, whether or not to change the actuating time is taken. If the actuating time is to be changed, then a further decision is taken to decide if the actuating time should be adjusted or cancelled, and depending on the decision, the actuating time is adjusted or cancelled.

### BRIEF DESCRIPTION OF THE DRAWINGS

A more complete understanding of the present invention may be had by reference to the following Detailed Description when taken in conjunction with the accompanying drawings wherein:

FIG. 1 depicts a simplified block diagram of a dynamic time actuating system according to a first preferred embodiment of the invention;

FIG. 2 depicts a simplified block diagram of a dynamic time actuating system according to a second preferred embodiment of the invention; and

FIG. 3 depicts a flow chart for the method according to the invention.

### DETAILED DESCRIPTION OF EMBODIMENTS

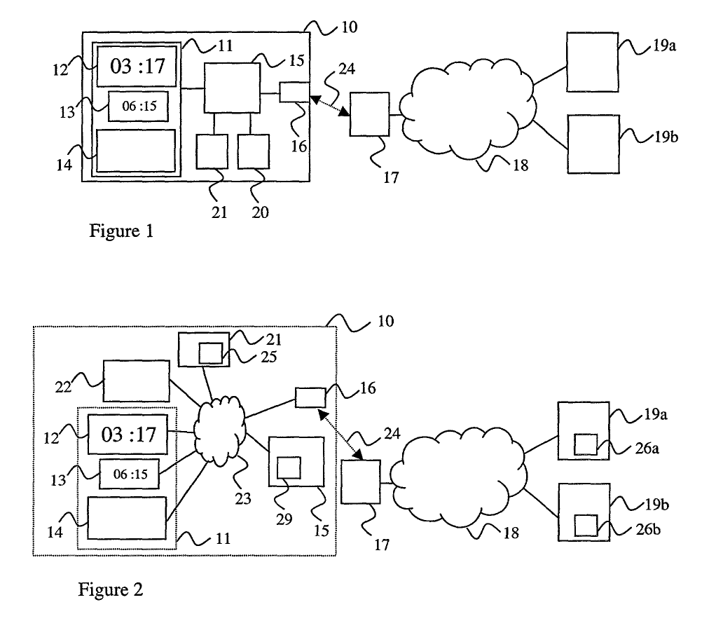

Reference is now made to the Drawings, where FIG. 1 shows a first preferred embodiment of the dynamic time actuating system according to the invention. The dynamic time actuating system 10 has an area for user interaction 11, often a Graphical User Interface (GUI). This area 11, that may comprise a display 12 for the current time and a display 13 for the actuating time, i.e. the time to actuate a predefined function, where the time may further comprise a date. The area 11 further comprises an input/output area 14 where the user can set the actuating time and choose the criteria for adjustment of the actuating time. The input/output area 14 may comprise a time setting unit to set the actuating time, an external factor setting unit for identifying external factors, a condition unit for setting conditions related to the actuating time and the external factors and a function setting unit for selecting the at least one function to be performed at the actuating time. This input/output area 14 may for example be a miniature keyboard or touch sensitive panel, possibly with character recognition and/or voice recognition capabilities, making it easy for the user to enter any commands. It should be understood that the various components in FIG. 1 are not necessarily drawn to scale.

The actuating system 10 further comprises at least one processor 15 that controls the actuating system 10 and, among other things, computes the changes of the actuating time, and a memory 21 for information storage. Furthermore, the actuating system 10 may comprise an effectuating unit 20 to effectuate the predefined function and a communication unit 16, such as for example a modem or an Internet connection. The actuating system 10 can, through the communication unit 16, access the Internet 18 or other networks (not shown), often through an intermediary device 17, such as for example a server or a gatekeeper. The communication unit 16 communicates with the intermediary device 17 via a link 24 that can be either a wireline connection or, preferably, a wireless connection using for example but not limited thereto Bluetooth technology.

Both the Internet 18 and the intermediary device 17 are external to the actuating system 10, as are a plurality of servers 19 that are connected to the Internet 18 (or the other networks). These servers 19 may be used by for instance companies providing weather forecasts, public transport companies, airports, golf courses, police departments, and stock exchange quote servers. Examples of services provided by these servers 19 are:

weather services: the current (or forecast) temperature, precipitation, and wind;

public transport: information regarding the status of the public transport network as a whole or certain lines, as for example whether bus line 17 runs as it should, or whether the predicted time for a certain journey exceeds a pre-set time;

airports: estimated time of arrivals and departures, as well as predicted travel times to and from the airport;

golf courses: information about the status of the greens, whether the course is open, and the availability of times to play golf;

ski resorts: information about the skiing conditions and estimates of the number of skiers for the day; and

police departments: traffic flow situations.

These were merely examples of the possibilities, and it should be understood that the present invention is not limited to receiving input only from the enumerated service devices but from many other service devices as well.

The functions of the present invention may be better understood with reference to the following exemplary scenario wherein it is assumed that a person, let us call him Alex, has the next day off. He would like to play golf relatively early at a course some distance away from his home, but only if the weather is acceptable to him and, of course, if the golf course is open and it is possible to play. Alex therefor uses the GUI 11 of his actuating system 10 to access the following servers 19 (which are assumed to provide the correct services) through the Internet 18 to access the following information and to program the actuating system 10 accordingly:

he sets a conditional actuating time, in this case a wake-up time, that is only valid under certain conditions, and possibly one or more further actuating times;

he chooses a weather service server 19 and selects an external factor and a condition associated with it, i.e. he only wants the alarm to sound if it has not rained in the area around the golf course at the conditional actuating time the next day, and if no rain is forecast for the first half of the next day;

he further indicates that he only wants the alarm to go off if the wind is less than 12 m/s and if no wind exceeding the limit is forecast for the first half of the next day;

he chooses the server 19 for the golf course and programs the actuating system not to sound the alarm if the golf course, at the time of the conditional actuating time, is marked as closed for the morning of that day; and

chooses a server 19 with traffic flow services and instructs the actuating system 10 to sound the alarm a certain number of minutes earlier if the predicted travel time between for example his home and the golf course exceeds a certain pre-set time, where the number of minutes is equal to the difference between the pre-set time and the predicted time thus compensating for any delays on the road.

If Alex has accessed the servers 19 before and knows the services they provide, he could have them stored in the memory 21 of the actuating system 10 and thereby setting them off-line. This means he does not have to log on to any other system to program his actuating system 10. Alternatively, the actuating system 10 could present a list (not shown) of all the possible settings it has stored in its memory 21. This would make it relatively easy for Alex to simply mark the servers 19 he wants to use for the actuating time computation and to change the particulars of each case if necessary, i.e. for example if he wants to use the weather service, but does not care about any tornado warnings for the next day.

It can be appreciated, from the example and otherwise, that there are two main kinds of conditions:

conditions that are only either true or false, i.e. they can only cancel an actuating time, and

conditions that can change an actuating time depending on the information received; these can all be said to become true at the actuating time.

In addition to these two kinds there is also a further kind of conditions that combine the two hereinbefore-mentioned kinds of conditions, i.e. it can both change and cancel an actuating time.

The processor 15 then waits for the first of the actuating times to draw near. A certain, pre-set amount of time, say 30 minutes, before the conditional actuating time, the processor 15 starts to access the servers 19 that may provide data that will change the actuating time. In this case, the processor 15 will access the server 19 that provides traffic related data, as this is the only data that may change the actuating time; the other conditions may cancel the actuating time, but not change it. The rationale behind starting to access the servers only a certain, pre-set time before the actuating time is that the actuating time should not change too much sometimes. If, for example, the road to the golf course is almost completely blocked, the actuating system might effectuate the alarm late in the evening the day before as it tries to compensate for the extra time it will take to get there. In addition or alternatively, the actuating system 10 could be instructed not to change the actuating time to an earlier time if the change is too big, such as for example four hours.

It is, of course, possible to use the actuating system 10 without any restrictions as to these matters. In this case, the actuating system 10 would start accessing the servers 19 for information that could change the actuating time immediately, and effectuate the predefined function whenever the calculations so indicate.

If the actuating system 10 now finds that it indeed needs to change the actuating time, it does so and monitors the development of the situation by sending further information requests to the server 19. Some time before the actuating time, such as for example five minutes before, the actuating system 10 contacts the other servers 19, asking for the relevant information. With the information at hand, the actuating system 10 now compares it with the conditions set by the user; in essence, the actuating system 10 performs a logical operation on all the conditions that can cancel the actuating time. If information matches all conditions, then the actuating system 10 actuates the predefined function, if possible preferably notifying the user about the reasons for changing the actuating time, if any. If the conditions do not match, however, then the actuating system 10 quietly passes the actuating time and waits for the next actuating time, if such a time has been set.

FIG. 2 illustrates a second preferred embodiment of the actuating system according to the invention. This figure depicts a more general embodiment than the embodiment shown in FIG. 1. FIG. 2 shows, using reference numbers from FIG. 1 where applicable, an actuating system 10 comprising a display 12 for the current time, a display 13 for the actuating time, an input/output area 14. The input/output area 14 may comprise a time setting unit to set the actuating time, an external factor setting unit for identifying external factors, a condition unit for setting conditions related to the actuating time and the external factors and a function setting unit for selecting the at least one function to be performed at the actuating time. The actuating system 10 also comprises at least one software program 29 residing in at least one processor 15, a memory 21, a effectuating unit 22 for effectuating a predefined function, and a network 23 interconnecting the parts of the actuating system 10. It should be understood that the actuating system 10 in FIG. 2 does not necessarily reside in a single box; its components may be physically separated. This is to say that some, or all, of the components comprised in the actuating system 10 may actually reside within other devices. The components may for example reside in a computer or a stereo (in which case the at least one software program 29 may be the only thing specific to the actuating system). This is indicated by dotted lines in FIG. 2, for the actuating system 10 and the Graphical User Interface (GUI) 11, comprising the display 12 for the current time, the display 13 for the actuating time, and the input/output area 14.

Some examples are given to facilitate comprehension of this:

the display 12 for the current time may be any clock connected to the network 23, for instance a clock hung on the wall or a clock comprised in a computer,

the display 13 for the actuating time may be a window in the computer or a display on a clock,

the input/output area 14 may be a touch sensitive area, a terminal, or the keyboard and screen of a computer,

the at least one processor 15 may be practically any processor that can operate the controls needed (i.e. relatively simple programs as is appreciated by anyone skilled in the art) and that is connected to the network,

the memory 21 may be practically any memory with sufficient storage space that is accessible from the network,

the effectuating unit 22 may for instance be a bell, the ringer of an alarm clock connected to the network, a stereo (emulating a clock radio), lamps, or an electrical switch.

The network 23, could be practically any kind of interconnecting network or combinations of networks, such as for example a Local Area Network (LAN), the Internet, and a radio network using for instance Bluetooth technology. This network 23 connects the display 12 for the current time, the display 13 for the actuating time, the input/output area 14, the at least one processor 15, the memory 21, and the device 22 for actuating the predefined function.

The actuating system 10 may also be comprised in devices like mobile phones. In this case, the information 26 on the external servers 19 can be accessed with virtually any kind of access technology, such as for instance SMS messages, Simple and Mobile IP connections, and Bluetooth connections, all well known in the Art.

As in FIG. 1, there is further shown a communication unit 16, the Internet 18, and an intermediary device 17, such as for example a server or a gatekeeper. The processor 15 is in contact with the communication unit 16 that communicates with the intermediary device 17 via a link 24 that can be either a wireline connection or, preferably, a wireless connection using for example Bluetooth technology. From the intermediary device 17, access is granted to the Internet 18 and external servers 19 as detailed hereinbefore.

Symbolically shown in FIG. 2 are one or more actuating times and conditions pertaining thereto 25, and information 26 stored on the servers 19.

Even though the actuating system 10 in this embodiment is quite different from the actuating system in the first embodiment described hereinbefore, it can be used with the necessary changes having been made in the same way as described hereinbefore.

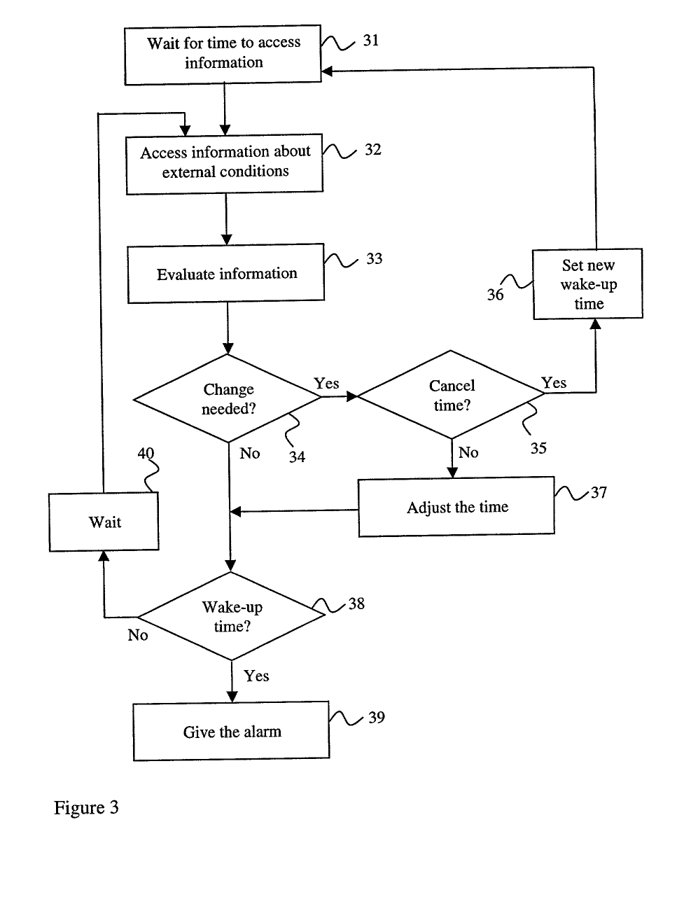

FIG. 3 shows a flow chart of the method according to the invention. In step 31, the processor 15 awaits the time when it should start accessing information for a possible adjustment of the actuating time. This time will usually be a certain, pre-set amount of time, such as for example 30 minutes, before the first conditional actuating time.

In step 32, the processor 15 accesses the servers 19 that may provide data that will change the actuating time. The processor 15 may now access information regarding some or all of the pre-set conditions, depending on the implementation. One option is to start by only accessing the information that may change the actuating time and wait with the information that may cancel the actuating time until a short time before the actuating time. This has the benefit that it keeps down the network traffic as some servers 19 will only be accessed once (if at all). Another option is to start out by accessing all the servers 19 for relevant information. This way the actuating time can be cancelled immediately if that is the case, for instance if the golf course is closed in the example given hereinbefore. Combinations of the options are also possible, and it is also possible to access just a sub-set of the servers each time.

In step 33, the processor 15 compiles and evaluates the information received in step 32, whereas a decision whether or not the actuating time should be changed is taken in step 34.

If the actuating time is to be changed, the processor 15 verifies whether or not the change is such that the actuating time should be cancelled for instance if the information does not match all the pre-set conditions; step 35. If the actuating time should be cancelled, the processor 15 cancels the actuating time in step 36 and moves on to the next actuating time that is stored in its memory 21. Thereafter it either returns to step 31 if there exists such an actuating time or ends the method if no such actuating time exists.

If the actuating time should indeed be changed and not cancelled, i.e. “No” in step 35, then the processor 15 adjusts the actuating time according to the information it received earlier; step 37.

If no change was needed, i.e. “No” in step 34, or if the actuating time was adjusted, the processor 15 proceeds with step 38, in which a control is made to see if the predetermined functions should be actuated. If so, the functions are actuated in step 39 after which the method ends. If possible and desired, the processor 15 informs the user about various relevant information related to the actuating time conditions, such as for example “It's 5.45, the weather is good and the golf course is open!”

If it is found in step 38 that the actuating time has not yet come, the method proceeds in step 40, in which a period of waiting occurs. The length of the waiting period is usually shorter the closer to the actuating time it gets. As an example, if the method is started eight hours before the actuating time, the initial waiting period may be 30 minutes, a time that may be gradually shortened until it reaches five minutes 15 minutes before actuating time.

In some cases, for instance if two conditional actuating times are relatively close to each other, it may be preferable to have the processor 15 process all the actuating times at once, instead of starting with the first actuating time and process the second actuating time only after the first actuating time is cancelled.

The method according to the invention may also be implemented using parallel processing, multi-threading or similar techniques. In this case, the method need not strictly follow the method as described, but may for example have one process, thread or the like continuously monitoring whether or not the actuating time has arrived.

It should also be understood that the various devices comprised in the actuating system 10 are not necessarily separate from each other. There are instances when it might be preferable to compile two or more devices in a single device. An example of this is that it might be advantageous to have a single display for the display 12 for the current time and the display 13 for the actuating time, where they may either be shown simultaneously or alternating.

As can be seen from the description hereinbefore, there are provided actuating systems and a method for actuating predefined functions at actuating times that may be changed according to external factors.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A dynamic time actuating system comprising:
a time setting unit for setting an actuating time;
a function setting unit for selecting a function to be performed at the actuating time;
an external factor unit for identifying at least an external factor;
a condition setting unit for setting at least one condition about the at least one external factor regarding the actuating time;
a communication unit for obtaining information about the at least one external factor;
a processing unit for
comparing the information about the at least one external factor with the at least one condition; and
based on the actuating time and the result of the comparison, either changing the actuating time, deleting the actuating time or leaving the actuating time unchanged; and
an effectuating unit for effectuating the selected function at the actuating time.

2. The dynamic time actuating system according to claim 1, wherein the communication unit is for contacting one or more external servers to access the information.

3. The dynamic time actuating system according to claim 2, wherein the actuating system, prior to the actuating time, accesses the external information from the external servers in order to compare the information about the at least one external factor and the at least one condition.

4. The dynamic time actuating system according to claim 2, wherein the communication unit accesses the external information through a wireless connection.

5. The dynamic time actuating system according to claim 4, wherein the wireless connection is a Bluetooth connection.

6. The dynamic time actuating system according to claim 1, wherein the effectuating unit is an electrical switch.

7. The dynamic time actuating system according to claim 1, wherein the time setting unit further is for setting a second actuating time that is used as the actuating time if the original actuating time is deleted.

8. A method in an actuating system for operating a dynamic time actuating system, comprising steps of:
setting an actuating time;
selecting a function to be performed at the actuating time;
identifying at least an external factor;
setting at least one condition about the at least one external factor regarding the actuating time;
obtaining information about the external factor;
comparing the information about the at least one external factor and the at least one condition; and
based on the actuating time and the result of the comparison, either
changing the actuating time;
deleting the actuating time; or
leaving the actuating time unchanged; and
effectuating the selected function at the actuating time.

9. The method according to claim 8, wherein the step of obtaining information about the external factor further comprises the step of contacting one or more external servers to access the external information.

10. The method according to claim 9, wherein the steps of accessing the external information from the external servers, obtaining information about the external factor, and comparing the information about the at least one external factor and the at least one condition are performed prior to an actuating time.

11. The method according to claim 9, wherein the step of contacting one or more external servers to access the external information is performed via a wireless connection.

12. The method according to claim 11, wherein the wireless connection is a Bluetooth connection.

13. The method according to claim 8, wherein the selected function is effectuated by triggering an electrical switch.

14. The method according to claim 8, further comprising the steps of:
setting a second actuating time; and
making the second actuating time the actuating time if the original actuating time is deleted.

15. A method in an actuating system for changing the actuating time according to external factors, wherein a user has stored at least one actuating time and a plurality of conditions relating to the external factors, the method comprising the steps of:
accessing information about the external factors relating to the conditions,
evaluating the information with regard to the conditions to decide whether or not to change the actuating time,
if the actuating time is to be changed,
deciding, based on the information and the conditions, whether to change or delete the actuating time, and depending on the decision, and
changing or deleting the actuating time.

16. The method according to claim 15, further comprising, prior to the step of accessing information about the external factors relating to the conditions, the step of waiting to a certain pre-set time before the actuating time.

17. The method according to claim 15, wherein at least part of the information about the external factors is accessed via the Internet.
